(19) United States
(12) Patent Application Publication
(10) Pub. No.: US 2022/0094658 A1
(43) Pub. Date: Mar. 24, 2022

(54) SYSTEMS AND METHODS FOR INTERACTIVE EXCHANGE OF MEDIA MESSAGES

(71) Applicant: META PLATFORMS, INC., Menlo Park, CA (US)

(72) Inventors: Hemal Shah, Palo Alto, CA (US); Aayushi Kaushik, San Francisco, CA (US); Justin David Aguilar, San Francisco, CA (US); Ian McIntyre Silber, San Jose, CA (US); Nilesh Vinubhai Patel, Mountain View, CA (US)

(21) Appl. No.: 16/016,505

(22) Filed: Jun. 22, 2018

(51) Int. Cl. H04L 12/58

(52) U.S. Cl. CPC H04L 51/32; H04L 51/16; H04L 51/046

(57) ABSTRACT

Systems, methods, and non-transitory computer-readable media can provide a first user with a first media message from a second user. A selection is received from the first user to generate a second media message that is responsive to the first media message. A composer interface to generate the second media message is provided. The composer interface comprises a camera interface and a reference sticker comprising at least a portion of the first media message.

### FIELD OF THE INVENTION

The present technology relates to the field of content sharing. More particularly, the present technology relates to techniques for providing responses to digital media content that is interactively exchanged.

### BACKGROUND

Users often utilize computing devices for a wide variety of purposes. Users can use their computing devices to, for example, interact with one another, access media content, share media content, and create media content. In some cases, media content can be exchanged and/or provided by members of a social networking system. The media content can include one or a combination of text, images, videos, and audio. The media content may be published to the social networking system for consumption by others. Media content can be published, for example, in a profile of a member of the social networking system, or in various content feeds of various members of the social networking system. Users can also interact with one another and share content using a messaging interface to exchange messages with one or more other users.

### SUMMARY

Various embodiments of the present disclosure can include systems, methods, and non-transitory computer readable media configured to provide a first user with a first media message from a second user. A selection is received from the first user to generate a second media message that is responsive to the first media message. A composer interface to generate the second media message is provided. The composer interface comprises a camera interface and a reference sticker comprising at least a portion of the first media message.

In an embodiment, a message thread including the first user and the second user is maintained. The message thread comprises a first notification associated with the first media message, and a second notification associated with the second media message.

In an embodiment, the first notification is selectable to open the first media message, and the second notification is selectable to open the second media message.

In an embodiment, the first media message is responsive to a content post provided by the first user to a social networking system.

In an embodiment, the content post is an ephemeral content post provided to an ephemeral content feed.

In an embodiment, the first media message is an ephemeral media message.

In an embodiment, the first media message is accessible to be viewed a pre-determined number of times.

In an embodiment, the second media message is an ephemeral media message.

In an embodiment, the second media message is classified as an ephemeral media message based on the first media message being an ephemeral media message and based on the second media message being responsive to the first media message.

In an embodiment, the composer interface allows the user to perform at least one of: rotating, resizing, or repositioning the reference sticker.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a content provider module, according to an embodiment of the present disclosure.

FIG. 2 illustrates an example messaging module, according to an embodiment of the present disclosure.

FIGS. 3A-3G illustrate example user interfaces, according to an embodiment of the present disclosure.

FIG. 4 illustrates an example method associated with generating a responsive media message, according to an embodiment of the present disclosure.

FIG. 5 illustrates an example method associated with generating a responsive media message, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Sharing Content

As mentioned, users often utilize computing devices for a wide variety of purposes. Users can use their computing devices to, for example, interact with one another, access media content, share media content, and create media content. In some cases, media content can be exchanged and/or provided by members of a social networking system. The media content can include one or a combination of text, images, videos, and audio. The media content may be published to the social networking system for consumption by others. Media content can be published, for example, in a profile of a member of the social networking system, or in various content feeds of various members of the social networking system. Users can also interact with one another and share content using a messaging interface to exchange messages with one or more other users.

Under conventional approaches, users can confront various challenges when exchanging messages (e.g., content) with other users through a social networking system. In some instances, users may wish to exchange media content which includes images and/or video. However, when multiple images or videos are exchanged in a messaging thread, and users respond to such messages, it may not be immediately clear which image or video a given response is directed to. Additionally, in some instances, users may want to send certain messages without having to worry about those messages being accessible for some extended period of time. Having the option to send messages with limited lifespan can help users express themselves more fully when communicating with other users. For example, a user may be more willing to send a video of the user singing if the video is accessible for only a limited period of time. Conventional approaches may provide the option to exchange ephemeral messages that have a limited lifespan. However, such scenarios can further exacerbate the previously discussed challenge in which it may not be clear what image or video a message is responding to, as the original image or video may be removed from the messaging thread (e.g., due to its limited lifespan). Accordingly, conventional approaches to computerized messaging systems may not adequately address these and other related challenges.

An improved approach rooted in computer technology overcomes the foregoing and other disadvantages associated with conventional approaches specifically arising in the realm of computer technology. In general, systems, methods, and computer readable media of the present technology can provide a first user with a first media message from a second user via a messaging interface. In various embodiments, a media message can be a message comprising at least one of a video or an image. A selection can be received from the first user to generate a second media message responsive to the first media message. The second media message can include at least a portion of the first media message to indicate that the second media message is in response to the first media message. For example, the second media message can include at least a portion of an image or video that was included in the first media message. The second media message can be transmitted to the second user. More details relating to the disclosed technology are provided below.

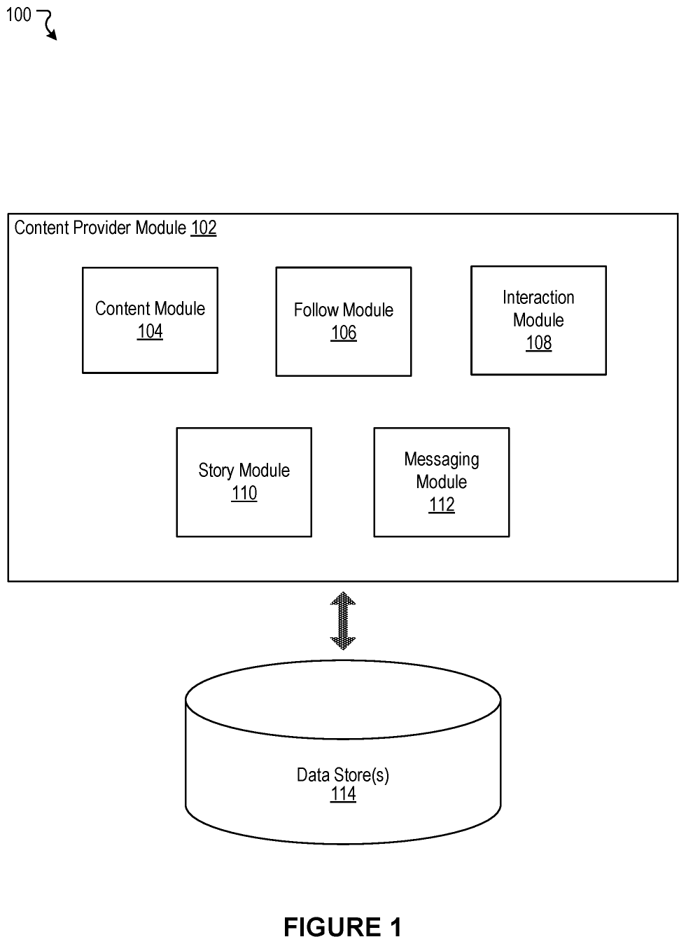

FIG. 1 illustrates an example system 100 including a content provider module 102, according to an embodiment of the present disclosure. The content provider module 102 can provide tools within a user interface with which users can exchange media messages. In an embodiment, a media message can be a message that comprises at least one of an image or a video. For example, the content provider module 102 can provide an interface via which a first user can view a first media message transmitted by a second user. The first user can select an option to generate a second media message that is responsive to the first media message. The content provider module 102 can provide an interface that the user can interact with to generate the second media message. For example, the content provider module 102 can provide a composer view which depicts and/or reflects subject matter at which a camera (e.g., a camera on the first user's computing device) is pointed. The first user can use the composer view to capture, select, or otherwise create an image or video to be included in the second media message. In an embodiment, the second media message can include at least a portion of the first media message to indicate that the second media message is responsive to the first media message. The content provider module 102 can transmit the second media message to the second user.

As shown in the example of FIG. 1, the content provider module 102 can include a content module 104, a follow module 106, an interaction module 108, a story module 110, and a messaging module 112. In some instances, the example system 100 can include at least one data store 114. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the content provider module 102 can be implemented in any suitable combinations.

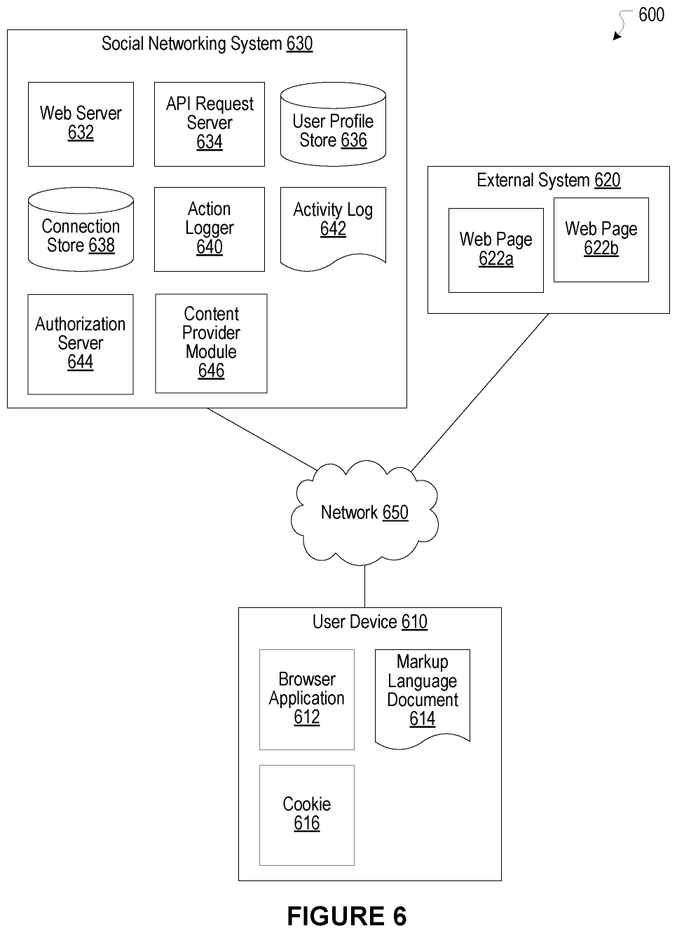

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be, in part or in whole, implemented as software running on one or more computing devices or systems, such as on a server system or a client computing device. In some instances, the content provider module 102 can be, in part or in whole, implemented within or configured to operate in conjunction with or be integrated with a social networking system (or service), such as a social networking system 630 of FIG. 6. Likewise, in some instances, the content provider module 102 can be, in part or in whole, implemented within or configured to operate in conjunction with or be integrated with a client computing device, such as the user device 610 of FIG. 6. For example, the content provider module 102 can be implemented as or within a dedicated application (e.g., app), a program, or an applet running on a user computing device or client computing system. The application incorporating or implementing instructions for performing functionality of the content provider module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The content provider module 102 can be configured to communicate and/or operate with the at least one data store 114, as shown in the example system 100. The data store 114 can be configured to store and maintain various types of data. In some implementations, the data store 114 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 114 can store information that is utilized by the content provider module 102. For example, the data store 114 can store various media messages, message threads, user preferences, and the like. It is contemplated that there can be many variations or other possibilities.

The content module 104 can be configured to provide users with access to content that is available through a social networking system. In some instances, this content can include content items that are posted in content feeds accessible through the social networking system. For example, the content module 104 can provide a first user with access to content items through an interface that is provided by a software application (e.g., a social networking application) running on a computing device of the first user. The first user can also interact with the interface to post content items to the social networking system. Such content items may include text, images, audio, and videos, to name some examples. For example, the first user can submit a post to be published through the social networking system. In some embodiments, the post can include, or reference, one or more content items.

In various embodiments, other users of the social networking system can access content items posted by the first user. In one example, the other users can access the content items by searching for the first user by user name through an interface provided by a software application (e.g., a social networking application, browser, etc.) running on their respective computing devices. In some instances, some users may want to see content items posted by the first user in their respective content feeds. To cause content items posted by the first user to be included in their respective content feed, a user can select an option through the interface to subscribe to, or “follow”, the first user. The follow module 106 can process the user's request by identifying the user as a follower of (or “friend” of) the first user in the social networking system. As a result, some or all content items that are posted by the first user can automatically be included in the respective content feed of the user. If the user decides that they no longer want to see content from the first user in their respective content feed, the user can select an option through the interface to unsubscribe from, or “unfollow”, the first user. As a result, the follow module 106 can remove the association between the user and the first user so that content items posted by the first user are no longer included in the content feed of the user.

In some instances, users may want to interact with posted content items. For example, a user may want to endorse, or “like”, a content item. In this example, the user can select an option provided in the interface to like the desired content item. The interaction module 108 can determine when a user likes a given content item and can store information describing this relationship. The interaction module 108 can also determine when other forms of user interaction are performed and can store information describing the interaction (e.g., information describing the type of interaction, the identity of the user, the identity of the user that posted the content item, and the content item, to name some examples). For example, the user may want to post a comment in response to a content item. In this example, the user can select an option provided in the interface to enter and post the comment for the desired content item. The interaction module 108 can determine when a user posts a comment in response to a given content item and can store information describing this relationship. In certain instances, a comment posted in response to a given content item may be transmitted as a message to the user that posted the content item. Other forms of user interaction can include emoji-based reactions to a content item (e.g., selecting an option that corresponds to a particular reaction, e.g., happy, sad, angry, etc.) and re-sharing a content item, for example.

In some embodiments, the story module 110 can provide an option that allows users to post their content as stories. In such embodiments, each user has a corresponding story feed in which the user can post content. When a user's story feed is accessed by another user, the story module 110 can provide content posted in the story feed to the other user for viewing. In general, content posted in a user's story feed may be accessible by any user of the social networking system. In some embodiments, content posted in a user's story feed may only be accessible to followers of the user. In some embodiments, user stories expire after a pre-defined time interval (e.g., every 24 hours). In such embodiments, content posted as a story in a story feed is treated as ephemeral content that is made inaccessible once the pre-defined time interval has elapsed. In contrast, content posted in a user (or follower) primary content feed can be treated as non-ephemeral content that remains accessible for a longer and/or an indefinite period of time.

The messaging module 112 can be configured to provide messaging options to users of the social networking system. For example, the messaging module 112 can generate and/or provide one or more graphical user interfaces through which users can create, access, and exchange messages with other users of the social networking system. The one or more graphical user interfaces may be provided to a computing device and presented through a software application (e.g., social networking application) running on the computing device. Messages created, accessed, and/or exchanged by users can include media messages. In an embodiment, a media message can include at least one of an image or a video. Users can also create, access, and/or exchange responsive media messages that are responsive to a previous media message.

In various embodiments, a message (including a media message) may be sent as an ephemeral message or a non-ephemeral message. In some embodiments, an ephemeral message sent to a designated recipient can remain accessible to the recipient until some pre-defined event or some pre-defined period of time. For example, the ephemeral message can remain accessible to the recipient until the recipient has accessed (e.g., seen) the ephemeral message, or until a pre-determined lifespan has expired (e.g., after 24 hours). In instances where the ephemeral message was sent to a group of users, the ephemeral message can remain accessible to each recipient in the group until that recipient has accessed (e.g., seen) the ephemeral message. In some embodiments, a non-ephemeral message can be accessible to a designated recipient for an indefinite period of time (e.g., permanently) without having its expiration, if any, being conditioned on some pre-defined event or some pre-defined period of time.

The messaging module 112 can create and/or maintain a message thread for a group of users (e.g., a user and one or more other users). A message thread for a group of users can be created, for example, when an initial message is communicated among users in the group. The message thread can be used to manage communications between the users in the group on an on-going basis. The membership of such message threads can vary over time, for example, as new users are added to the group or when existing users leave the group. As mentioned, in certain embodiments, a media message can include at least one of an image or a video. A message thread can include both non-media messages (e.g., textual messages) as well as media messages exchanged by users in the message thread. In certain embodiments, a message thread may include a notification or indication of a media message, but may require a user to select the notification to access the media message. For example, a notification may read “Peter has sent you a media message.” A user can select the notification to open a full-screen display of the media message. In certain embodiments, and in certain instances, media message notifications may differ based on the relationship or role of, or action by, a user with respect to the notification. For example, consider an example scenario in which a first user, User A, shares a media message in a message thread with a plurality of other users. Each other user in the message thread may receive within the message thread a notification that reads “User A sent a media message,” while User A may see a notification that reads “You sent a media message.” Consider a further scenario in which User B responds to User A's media message with a responsive media message. User A's computing device may display a notification in the message thread that reads “User B sent a media reply to your media message,” and User B may see a notification that reads “You sent a media reply to User A's media message,” while each other user's computing device may display a notification that reads “User B sent a media reply to User A's media message.”

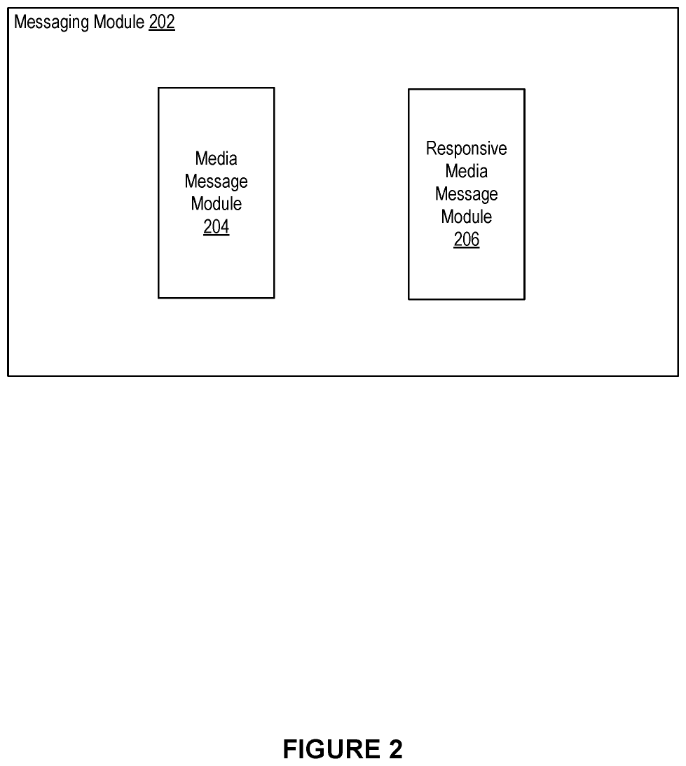

As mentioned, a user has the option to send messages as ephemeral messages and/or non-ephemeral messages. In certain instances, a message thread can provide users with access to both ephemeral and non-ephemeral messages. However, when an ephemeral message expires (e.g., after it has been accessed by a receiving user, or after a pre-determined period of time), the ephemeral message may no longer be accessible within the message thread. In certain embodiments, a placeholder or indicator associated with an ephemeral message can remain after the ephemeral message has expired. In an embodiment, only media messages may be transmitted as ephemeral messages, such that textual messages that do not include an image or video cannot be transmitted as ephemeral messages. More details regarding the messaging module 112 will be provided below with reference to FIG. 2.

FIG. 2 illustrates an example messaging module 202, according to an embodiment of the present disclosure. In some embodiments, the messaging module 112 of FIG. 1 can be implemented with the messaging module 202. As shown in the example of FIG. 2, the messaging module 202 can include a media message module 204 and a responsive media message module 206.

The media message module 204 can be configured to provide functionality for creating, sending, and accessing media messages. For example, a user can select an option to create a media message. Upon selecting the option, the user can create the media message and identify one or more recipients of the media message. The media message module 204 can provide a composer interface for a user to generate a media message. The composer interface can include a camera interface to capture visual content using a camera. The camera interface can include, for example, a viewfinder display that provides a real-time display of image content reflecting subject matter at which a camera (e.g., a camera on the user's computing device) is pointed. The camera interface can also include a shutter button. When the user clicks the shutter button, the media message module 204 can capture image content displayed in the viewfinder display (e.g., an image or a video) and use the captured image content for the media message.

The media message module 204 can also provide tools to add and/or modify visual content for a media message. For example, the composer interface can provide a user with tools to apply one or more filters, frames, masks, or other visual effects to a media message. In another example, the composer interface can provide a user with tools to draw visual content. In yet another example, the composer interface can provide a user with tools to add one or more stickers to visual content.

As mentioned, in an embodiment, a media message can be transmitted as an ephemeral message. For example, in some embodiments, an ephemeral media message sent to a designated recipient can be accessible by the recipient until some pre-defined event. For example, the ephemeral media message can remain accessible to the recipient until the recipient has accessed (e.g., seen) the ephemeral media message through the social networking system. In instances where the ephemeral media message was sent to a group of users, the ephemeral media message can remain accessible to each recipient in the group until that recipient has accessed (e.g., seen) the ephemeral media message through the social networking system. In some embodiments, an ephemeral media message accessed during a given session can continue to be accessed by the user during the same session for some pre-defined period of time. In some embodiments, a session may be defined as a duration of time during which the user accesses a message thread through which the ephemeral media message was received.

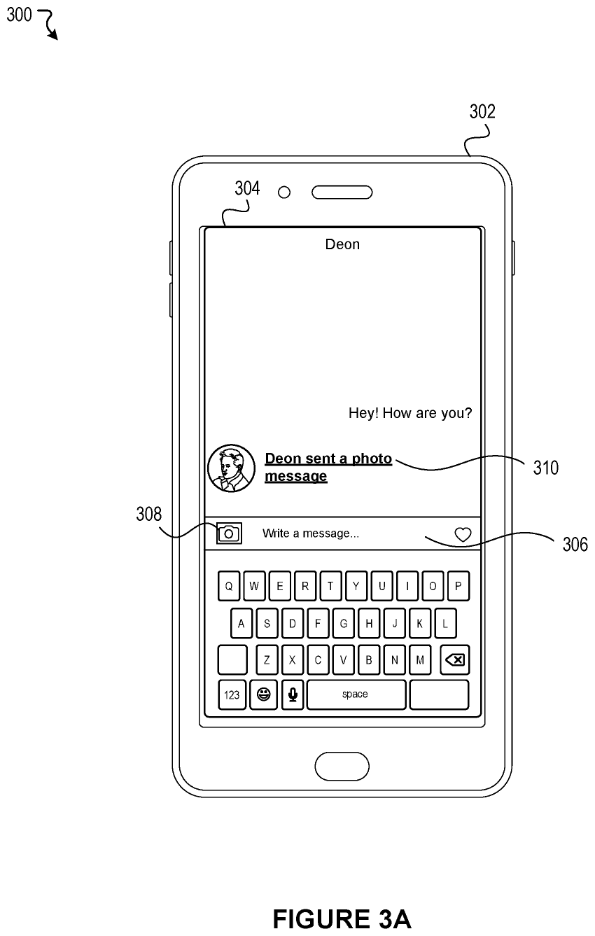

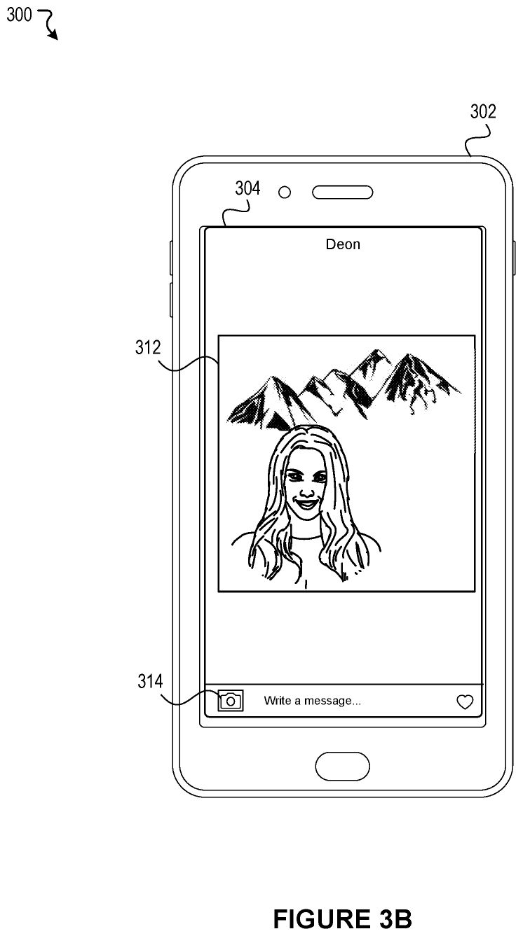

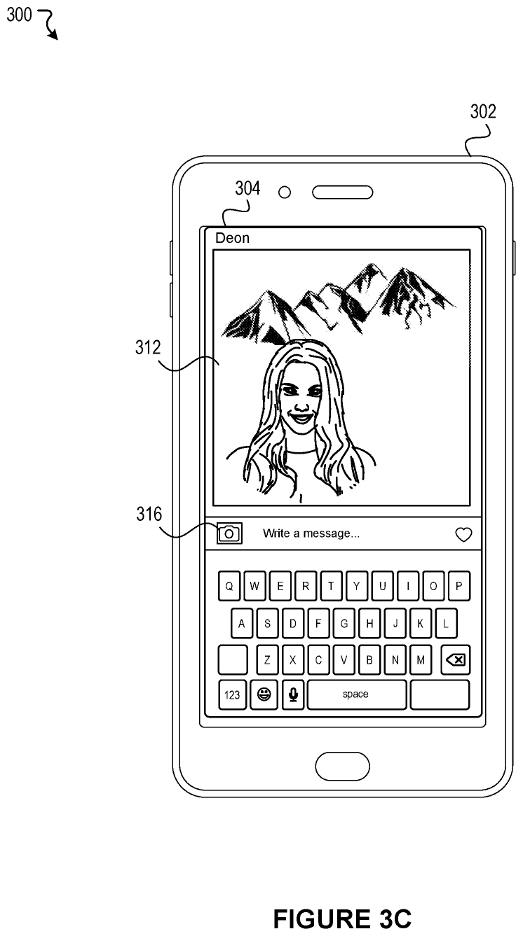

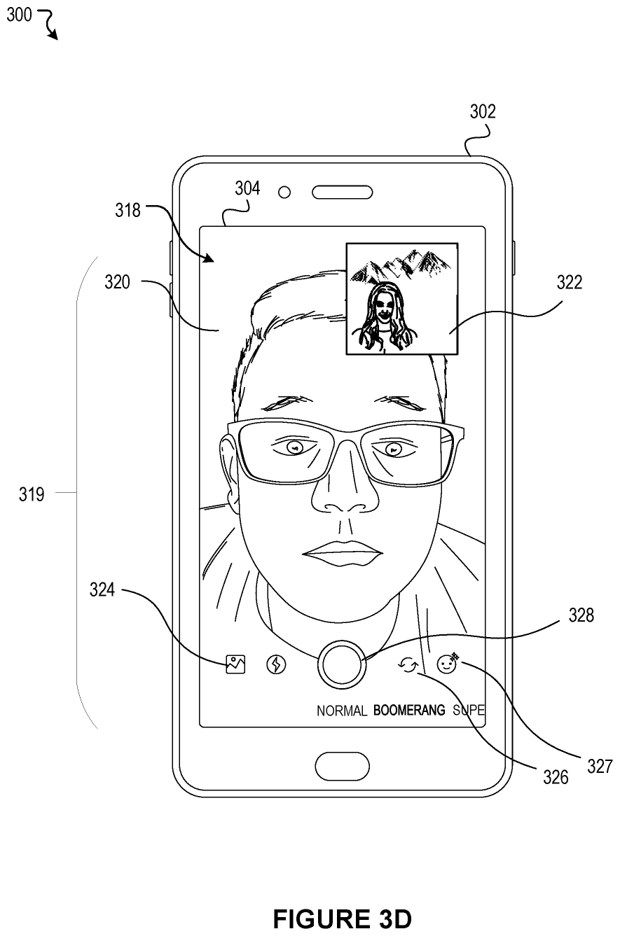

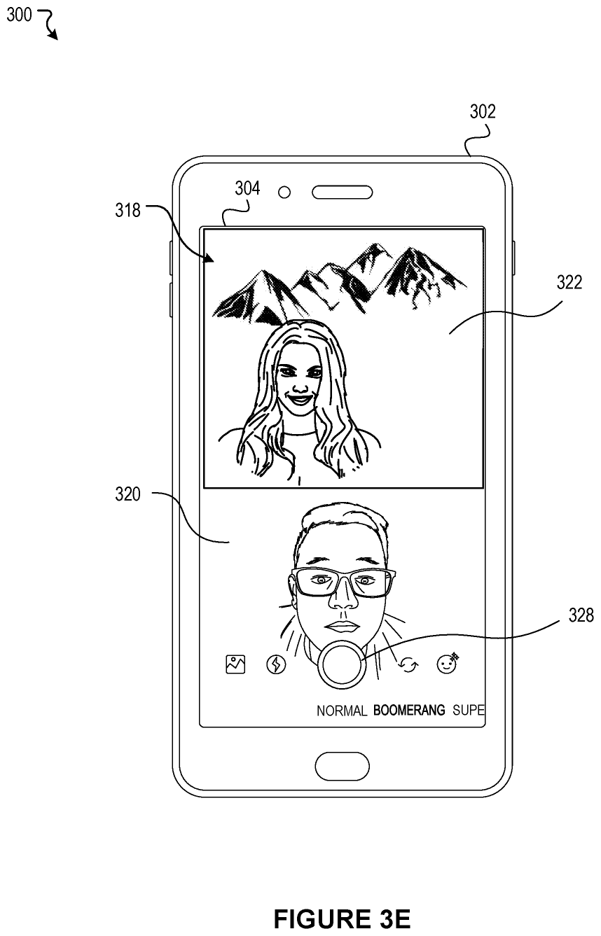

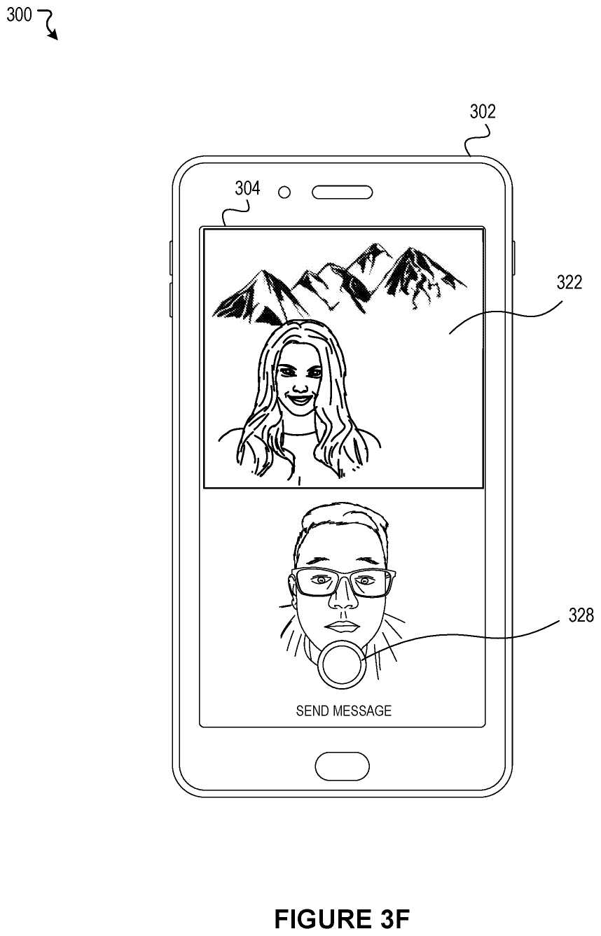

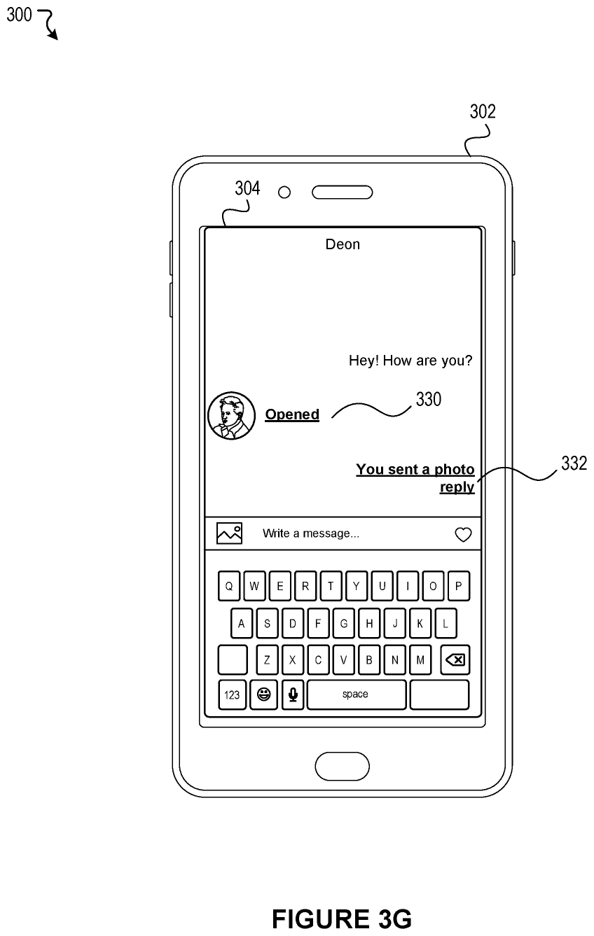

In certain embodiments, a media message can be transmitted as a non-ephemeral message. In some embodiments, a non-ephemeral media message can be accessible to one or more designated recipients for an indefinite period of time (e.g., permanently) without having its expiration, if any, being conditioned on some pre-defined event or some pre-defined period of time. Various additional functionality of the media message module 204 will be provided below in reference to FIGS. 3A-3G.

The responsive media message module 206 can be configured to provide various options for generating and sharing responsive media messages through the social networking system. As mentioned, users typically have the option to reply to media content posted by other users on a social networking system. Such content can include media content shared as messages or media content that is posted to one or more content feeds. In one embodiment, when a user receives a media message, the responsive media message module 206 can provide the user with the option to reply with a responsive media message. If the user selects that option, the responsive media message module 206 can open a composer interface that the user can interact with to generate a responsive media message. The composer interface used to generate a responsive media message may be substantially similar to the composer interface described above for generating media messages. However, in certain embodiments, a responsive media message can include at least a portion of a previous media message that the responsive media message is responsive to. For example, consider an example scenario in which a first user receives a first media message from a second user, the first media message including a first image. The responsive media message module 206 can provide the first user with the option to generate a responsive media message in response to the first media message. If the first user selects that option, the responsive media message module 206 can open a composer interface that the user can use to generate a responsive media message. As discussed above with reference to the media message module 204, the composer interface can include, for example, a camera interface and/or one or more tools for the user to use to generate the responsive media message. However, because the user is generating a responsive media message that responds to a previous media message (i.e., the first media message), the composer interface can also include at least a portion of the first media message. For example, the composer interface can include the first image as a sticker, i.e., a reference sticker. By including the reference sticker within the responsive media message, it is made clear which previously shared media message a responsive media message is responding to. The user can interact with and/or manipulate the reference sticker using various interactions or operations. For example, the user can rotate the reference sticker (e.g., using a two-fingered rotation gesture on a touch screen), change the size of the reference sticker (e.g., using a pinching or spreading gesture), change a position of the reference sticker on the composer interface (e.g., using a dragging gesture), pin the reference sticker to a particular object within the composer window, and the like. Numerous variations are possible.

In certain embodiments, a particular interaction with a reference sticker may toggle the reference sticker between various pre-determined configurations. For example, when a user opens a composer interface to generate a responsive media message, the responsive media message module 206 can automatically generate a reference sticker having a first pre-determined configuration (e.g., size, orientation, and/or position). However, if the user interacts with the reference sticker in a particular way (e.g., by tapping on the reference sticker), the responsive media message module 206 can present the reference sticker within the composer interface in a second pre-determined configuration. If the user taps on the reference sticker again, the reference sticker can be presented in a third pre-determined configuration, and so forth. For example, the first pre-determined configuration may have the reference sticker in a top right corner of the display occupying less than a quarter of the composer interface, the second pre-determined configuration may have the reference sticker occupying a top half of the composer interface, and the third pre-determined configuration may have the reference sticker occupying the entire composer interface. Many variations are possible.

In certain embodiments, if a user is responding to a previous media message that includes a video, a frame from the video can be selected for use in the reference sticker. For example, a first frame of the video can be selected for use in the reference sticker. In certain embodiments, a user generating the responsive media message can select a particular frame from the previous media message video to use as the reference sticker.

In certain embodiments, when a responsive media message is transmitted to another user, media content items included in the responsive media message can be burned into a single layer. For example, while a user is generating a responsive media message, a reference sticker and a newly captured image may be treated as separate media content items that can be individually manipulated. However, when the responsive media message is finalized and transmitted, the reference sticker and the captured image may be burned into a single layer such that they are transmitted as a single image.

In certain instances, if a second media message is responsive to a first media message, the second media message can include at least a portion of the first media message (e.g., as a reference sticker). If a third media message is responsive to the second media message, the third media message can include at least a portion of the second media message. Since the second media message includes at least a portion of the first media message, the third media message may include within it at least a portion of both the first and second media messages. This can go on for an indeterminate number of responsive media messages such that any later-generated responsive media message can include at least a portion of all previous media messages in the chain.

In certain embodiments, a comment to a content item posted in a content feed may be transmitted as a message to the user that posted the content item. For example, if a first user comments on an ephemeral content item posted in an ephemeral content feed (e.g., a story posted in a story feed), the comment may be provided to a posting user as a message from the first user to the posting user. The responsive media message module 206 can provide users with tools to generate media messages that are responsive to a content item in a content feed in a manner similar to that described above. When a user submits a responsive media message in response to a content item in a content feed, the responsive media message can be transmitted as a message in a message thread to a user that posted the content item. The responsive media message can include at least a portion of the posted content item that the media message is responsive to.

In certain embodiments, if a responsive media message is generated in response to ephemeral content (e.g., an ephemeral message, or an ephemeral content item posted to an ephemeral content feed), the responsive media message may be automatically transmitted as an ephemeral media message. For example, if a second media message is responsive to a first media message, and the first media message is an ephemeral media message, the second media message can be classified as an ephemeral media message based on the first media message being an ephemeral media message and based on the second media message being responsive to the first media message. Various additional functionality of the responsive media message module 206 will be provided below in reference to FIGS. 3A-3G.

FIG. 3A illustrates an example scenario 300, according to an embodiment of the present disclosure. The example scenario 300 includes an interface 304 that is presented through a display screen of a computing device 302. In various embodiments, the interface 304 may be provided through an application (e.g., a web browser, a social networking application, messenger application, etc.) running on the computing device 302 that is configured to interact with a social networking system. The interface 304 may be provided, for example, by the content provider module 102 described above.

In FIG. 3A, the interface 304 displays a message thread between a first user (e.g., “Ashok”) and another user named “Deon.” The interface 304 includes a text entry field 306 to enter text to transmit a standard, non-media message. The interface 304 also includes an icon 308 that the user can select to share an image or a video in a media message. In the example scenario 300, the first user has asked Deon “Hey! How are you?” and Deon has sent the first user a media message, as indicated by a notification 310. The first user can select the notification 310 to open the media message.

In FIG. 3B, the first user has selected the notification 310, and is presented with a photo 312 that Deon sent to the first user. The interface 304 includes a response field 314 that the first user can select to generate a response. In FIG. 3C, the first user is provided with a keyboard to generate a responsive textual message, or a camera icon 316 to generate a responsive media message.

In FIG. 3D, the first user has selected the camera icon 316 to open a composer interface 318. The first user can use the composer interface 318 to generate a responsive media message. The composer interface 318 includes a camera interface 319 for capturing an image or video. The camera interface 319 includes a viewfinder display 320 which depicts subject matter at which a camera of the computing device 302 is directed (in this case, it is the first user's face), a camera toggle icon 326 for the user to toggle between, for example, a front-facing camera and a rear-facing camera, and a shutter button 328 to capture an image or a video. The camera interface 319 also includes a filter icon 327 for applying a filter to content displayed in the viewfinder display 320. In addition to the camera interface 319, the composer interface 318 also includes a photo album icon 324 for the user to select a previously captured image or video for use in the responsive media message. The composer interface 318 also includes the photo 312 as a reference sticker 322. In FIG. 3D, the reference sticker 322 is set to a first pre-defined configuration. The first user can interact with the reference sticker 322 in various ways to rotate, re-position, and/or resize the reference sticker 322, as described above. The user can also interact with the reference sticker 322 to toggle between various pre-defined configurations. For example, in FIG. 3E, the first user has tapped on the reference sticker 322 to toggle to a second pre-defined configuration in which the reference sticker 322 occupies a top half of the composer interface 318, and the viewfinder display 320 occupies a bottom half of the composer interface 318. In FIG. 3F, the first user has selected the shutter button 328 to capture an image, and the shutter button 328 has converted into an option to send the media message to the other user, Deon. In certain embodiments, the first user may be provided with various tools (e.g., a draw tool, a sticker tool, etc.) to further modify and/or add to the responsive media message. In FIG. 3G, the first user has sent the responsive media message to Deon, which is indicated by a notification 332 within the message thread between the first user and Deon. The user Deon may have received a different notification, which may have read, for example, “Ashok sent a photo reply to your photo.” Deon could then select the notification on his computing device to open and view the responsive media message from the first user. Furthermore, the notification 310 of FIG. 3A has been converted into an “opened” notification 330 indicating that the first user has opened the media message from Deon. In certain embodiments, if the media message from Deon was an ephemeral message, the first user may no longer be able to access the first media message.

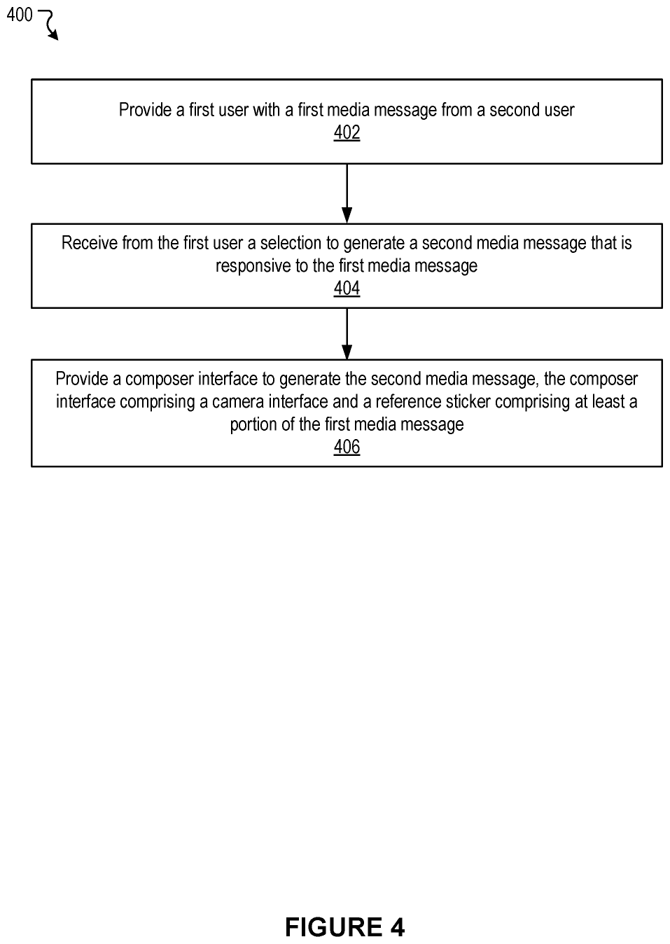

FIG. 4 illustrates an example method 400, according to an embodiment of the present disclosure. It should be appreciated that there can be additional, fewer, or alternative steps performed in similar or alternative orders, or in parallel, within the scope of the various embodiments discussed herein unless otherwise stated.

At block 402, the example method 400 can provide a first user with a first media message from a second user. At block 404, the example method 400 can receive from the first user a selection to generate a second media message that is responsive to the first media message. At block 406, the example method 400 can provide a composer interface to generate the second media message, the composer interface comprising a camera interface and a reference sticker comprising at least a portion of the first media message.

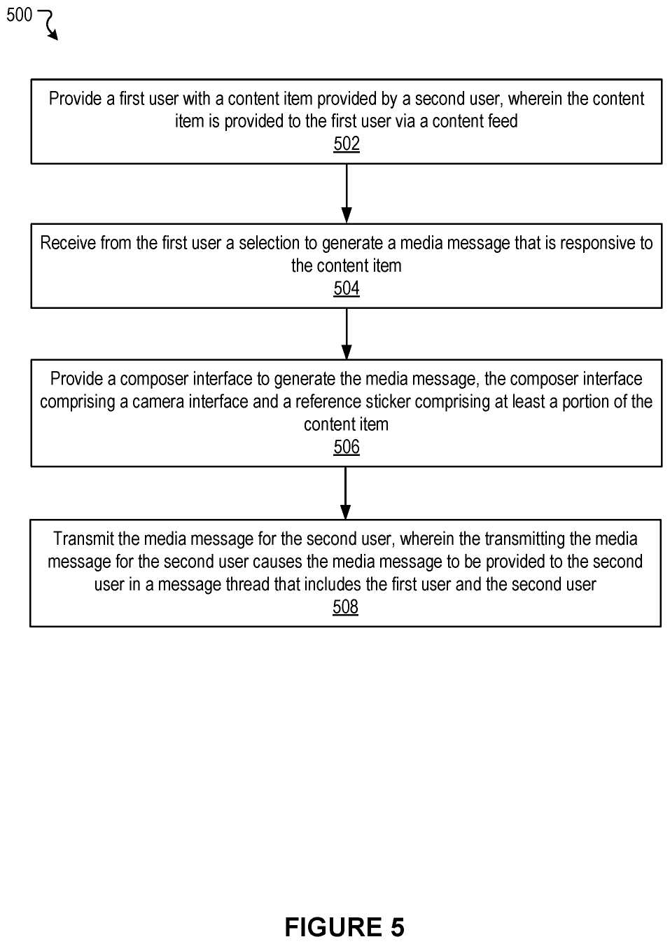

FIG. 5 illustrates an example method 500, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can provide a first user with a content item provided by a second user, wherein the content item is provided to the first user via a content feed. At block 504, the example method 500 can receive from the first user a selection to generate a media message that is responsive to the content item. At block 506, the example method 500 can provide a composer interface to generate the media message, the composer interface comprising a camera interface and a reference sticker comprising at least a portion of the content item. At block 508, the example method 500 can transmit the media message for the second user, wherein the transmitting the media message for the second user causes the media message to be provided to the second user in a message thread that includes the first user and the second user.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102, as discussed in more detail herein. As discussed previously, it should be appreciated that there can be many variations or other possibilities. For example, in some embodiments, one or more functionalities of the content provider module 646 can be implemented in the user device 610. As discussed previously, it should be appreciated that there can be many variations or other possibilities.

### Hardware Implementation

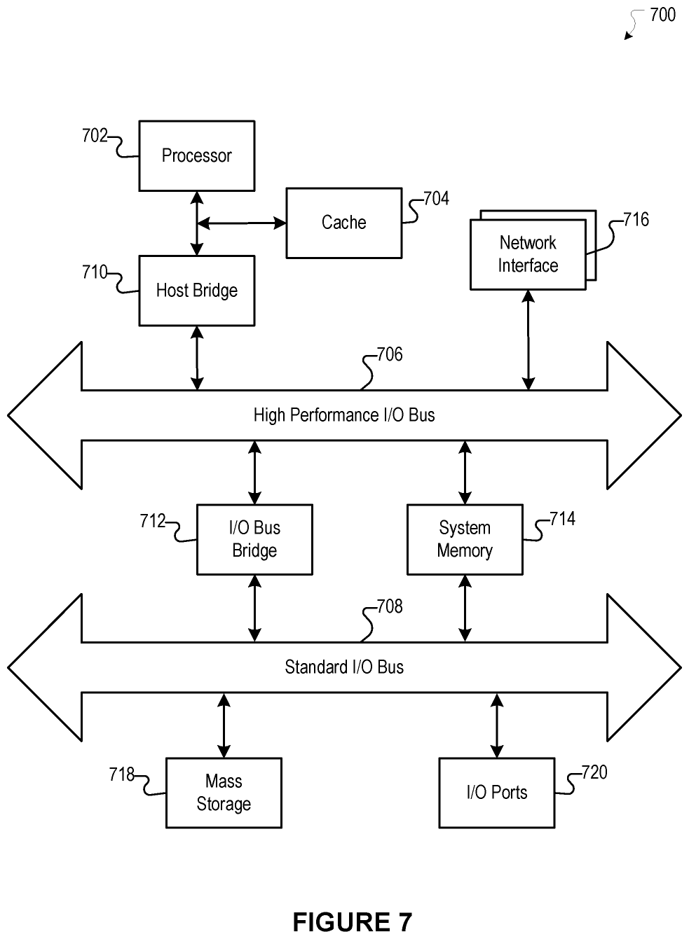

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
providing, by a computing system, a first user with a content item associated with a second user, wherein the content item is provided to the first user via a content feed associated with the first user;
receiving, by the computing system, a selection to generate a first media message that is responsive to the content item, the selection associated with the first user;
determining, by the computing system, that the content item is an ephemeral content post;
in response to the determining that the content item is an ephemeral content post, causing, by the computing system, the first media message to be an ephemeral media message;
providing, by the computing system, a composer interface to generate the first media message, the composer interface comprising a camera interface and a reference sticker including at least a portion of the content item;
in response to selection of a shutter button in the camera interface, generating, by the computing system, the first media message, wherein the first media message comprises a media content item captured by the camera interface and the reference sticker;
generating, by the computing system, a first notification associated with the first media message, the first notification selectable to open the first media message in a message thread that includes the first user and the second user;
transmitting, by the computing system, the first notification for the second user in a message thread that includes the first user and the second user;
receiving, by the computing system, an indication that the second user opened the first notification to access the first media message; and
providing, by the computing system, the first media message to the second user, wherein access to the first media message by the second user is limited to the same session in which the second user accesses the message thread.

2. The computer-implemented method of claim 1, further comprising:
maintaining the message thread; and
receiving a second media message that is responsive to the first media message from the second user;
wherein the message thread comprises a second notification associated with the second media message.

3. The computer-implemented method of claim 2, wherein the second notification is selectable to open the second media message.

4. The computer-implemented method of claim 1, wherein the content item is a video content item, wherein the portion is of a frame selected from the video content item, and wherein the frame has been selected by the first user.

5. The computer-implemented method of claim 1, wherein the first media message remains accessible to the second user until the second user has accessed the first media message.

6. The computer-implemented method of claim 1,
wherein the session is a duration of time during which the second user accesses the message thread.

7. The computer-implemented method of claim 1, wherein the first media message is accessible to be viewed a pre-determined number of times.

8. The computer-implemented method of claim 7, further comprising receiving a second media message that is responsive to the first media message from the second user, wherein the second media message is an ephemeral media message.

9. The computer-implemented method of claim 8, wherein the second media message is classified as an ephemeral media message based on the first media message being an ephemeral media message and based on the second media message being responsive to the first media message.

10. The computer-implemented method of claim 1, wherein the composer interface allows the user to perform at least one of: rotating, resizing, or repositioning the reference sticker.

11. A system comprising:
at least one processor; and
a memory storing instructions that, when executed by the at least one processor, cause the system to perform a method comprising:
providing a first user with a content item associated with a second user, wherein the content item is provided to the first user via a content feed associated with the first user;
receiving a selection to generate a first media message that is responsive to the content item, the selection associated with the first user;
determining that the content item is an ephemeral content post;
in response to the determining that the content item is an ephemeral content post, causing the first media message to be an ephemeral media message;
providing a composer interface to generate the first media message, the composer interface comprising a camera interface and a reference sticker including at least a portion of the content item;
in response to selection of a shutter button in the camera interface, generating the first media message, wherein the first media message comprises a media content item captured by the camera interface and the reference sticker;
generating a first notification associated with the first media message, the first notification selectable to open the first media message in a message thread that includes the first user and the second user;
transmitting the first notification for the second user in a message thread that includes the first user and the second user;
receiving an indication that the second user opened the first notification to access the first media message; and
providing the first media message to the second user, wherein access to the first media message by the second user is limited to the same session in which the second user accesses the message thread.

12. The system of claim 11, wherein the instructions, when executed by the at least one processor, further cause the system to perform:
maintaining the message thread; and
receiving a second media message that is responsive to the first media message from the second user;
wherein the message thread comprises a second notification associated with the second media message.

13. The system of claim 12, wherein the second notification is selectable to open the second media message.

14. The system of claim 11, wherein the content item is a video content item, wherein the portion is of a frame selected from the video content item, and wherein the frame has been selected by the first user.

15. The system of claim 11, wherein the first media message remains accessible to the second user until the second user has accessed the first media message.

16. A non-transitory computer-readable storage medium including instructions that, when executed by at least one processor of a computing system, cause the computing system to perform a method comprising:
providing a first user with a content item associated with a second user, wherein the content item is provided to the first user via a content feed associated with the first user;
receiving a selection to generate a first media message that is responsive to the content item, the selection associated with the first user;
determining that the content item is an ephemeral content post;
in response to the determining that the content item is an ephemeral content post, causing the first media message to be an ephemeral media message;
providing a composer interface to generate the first media message, the composer interface comprising a camera interface and a reference sticker including at least a portion of the content item;
in response to selection of a shutter button in the camera interface, generating the first media message, wherein the first media message comprises a media content item captured by the camera interface and the reference sticker;
generating a first notification associated with the first media message, the first notification selectable to open the first media message in a message thread that includes the first user and the second user;
transmitting the first notification for the second user in a message thread that includes the first user and the second user;
receiving an indication that the second user opened the first notification to access the first media message; and
providing the first media message to the second user, wherein access to the first media message by the second user is limited to the same session in which the second user accesses the message thread.

17. The non-transitory computer-readable storage medium of claim 16, wherein the instructions, when executed by the at least one processor, further cause the computing system to perform:
maintaining the message thread; and
receiving a second media message that is responsive to the first media message from the second user;
wherein the message thread comprises a second notification associated with the second media message.

18. The non-transitory computer-readable storage medium of claim 17, wherein the second notification is selectable to open the second media message.

19. The non-transitory computer-readable storage medium of claim 16, wherein the content item is a video content item, wherein the portion is of a frame selected from the video content item, and wherein the frame has been selected by the first user.

20. The non-transitory computer-readable storage medium of claim 16, wherein the first media message remains accessible to the second user until the second user has accessed the first media message.
